(19) United States
(12) Patent Application Publication
(10) Pub. No.: US 2002/0073116 A1
(43) Pub. Date: Jun. 13, 2002

(54) Compression/decompression method

(76) Inventor: Guy Middleton, Darley (GB)

Correspondence Address: SMITH & HOPEN PA, 15950 BAY VISTA DRIVE, SUITE 220, CLEARWATER, FL, 33760

(21) Appl. No.: 09/683,042

(22) Filed: Nov. 12, 2001

(30) Foreign Application Priority Data
May 13, 1999 (GB) 9911099.1

(51) Int. Cl. G06F 15/00; G06F 17/24

(52) U.S. Cl. 707/513; 707/530

(57) ABSTRACT

Computers connected to the Internet generally have loaded thereon a “browser” to enable the user of the computer to view information contained in Text Markup Language files known as web pages. The invention disclosed relates to a method of compressing web pages by replacing the most commonly used elements within the web page text files, known as tags, with a simple control code and simultaneously creating a look-up table string containing the control codes and the corresponding tags. The result is a compression string representative of the original web page file and a look-up string, both of which are inserted into a simple web page file having lines of code recognizable and executable by said browser. On receipt of said simple web page file, the browser recognizes and executes the code which works on the compression string using the look-up table string to expand said compression string which is then recognized by the browser as being in conventional web page file format. The invention has the added advantage of allowing a web page to be loaded and displayed as the expansion of the compression string is occurring.

### BACKGROUND OF THE INVENTION

This invention relates to a compression/decompression method, and more particularly to a compression/decompression technique for compression and expanding computer readable files which are to be transmitted from one computer and received by another computer over a medium of limited bandwidth, for example, across interlinked communications networks, or through space using infra-red or radio transmission techniques.

The explosive growth experienced in the information technology industry over the previous 20-30 years has resulted in a proliferation of new technologies, not least of which is generically termed “The lnternet” or “World Wide Web”. Although a comprehensive explanation of the Internet is beyond the scope of this application, a brief explanation of the practical mechanics of the Internet will clarify the invention to the reader.

The Internet is essentially a global network of computers each of which can communicate with a number of other computers also on that global network to allow for the worldwide transmission and reception of information. Redundancy is incorporated into the Internet in that any one computer on the Internet is linked to a plurality of others, so the failure of any one of those computers will not result in an overall failure of the Internet. Transmission of data over the Internet is essentially in the form of packets of data, which form part of the entire data being transmitted, and although one of the computers on the Internet may fail or be inactive at any one time, the data can still be transmitted albeit via a different route.

Aside from the permanent availability of the Internet and the concomitant facility for guaranteed data transmission at any time, the most practical benefit of the Internet has been for the retrieval of information by individuals by accessing the Internet or “web sites” sites. A web site is effectively a number of separate individual computer files containing text, graphics, animations, and the like which reside on portion of a hard disk drive of a computer connected to the Internet. Each web site consists of a plurality of different pages providing information concerning the particular company hosting that web site, a number of “links” which a user viewing the particular site on his computer can select using a computer mouse and be automatically redirected, either to another web page within that site or to a totally different site, and in many cases some advertisements for other companies who have web sites. Each of these advertisements itself constitutes a link to that company's web site.

A few companies operating computers connected to the Internet maintain databases of all the various web sites around the world and their content, and such companies have their own web sites, particular pages of which allow for a user to input one or two key words of a topic covered by web sites anywhere in the world. The search engine then queries the underlying database for matches and the database server automatically generates a web page consisting of a number of links to web sites around the world, the pages of which include the particular search terms entered by the user. It is to be mentioned that the Internet has been in existence since the 1970s, although it is only in the 1990s that it experienced explosive growth as global media, industrial and commercial organizations, governments, scientific and academic institutions, and world-wide business in general have begun to realize the potential of the Internet as a medium, primarily for selling. Although the Internet was originally invented for the provision and sharing of information between military and defense institutions in the USA, and was adopted subsequently by academic institutions for the same purpose, the Internet continues to be an invaluable resource for computer programmers, developers and the like, and it is up until recently the more computer literate individuals who have enjoyed the most benefit from the Internet at this time.

One of the fundamental disadvantages of the Internet as an information transmission medium is “bandwidth”. This term is broadly used to describe the transfer rate of a particular communication link. For example, a simple analogue telephone wire can carry data at a rate of 56 kbps (thousand bits per second), whereas a dedicated leased line connection is capable of transmitting data at speeds of up 10 Mbps and greater. Transatlantic cables laid by large telecommunications service providers can even transmit data at over 200 Mbs. The vast majority of the world's population however currently connect either at work over their employers local area network where the speed of data transmission and reception is directly affected by the number of computers on the network and the particular type of network being operated, or at home via a simple analogue telephone line. The vast majority of data is therefore transmitted and received slowly, and any reduction in the amount of data being transmitted would immediately improve the appeal of the Internet and furthermore reduce the costs of connecting thereto, which in the cases of a leased line connection may be in terms of many thousand pounds per annum.

Additionally, many Internet Service Providers (i.e. those companies which exist solely to provide Internet access to those companies and individuals whose computers or computer networks are not connected to the Internet) charge for access to the Internet by measuring the quantity of information, i.e. data transmitted through their servers to the particular user subscribing to their service.

To provide some indication of the magnitude of current Internet traffic, or at least the quantity of data that is currently available, there are, at the earliest filing date of this application, approximately 150 million users of the Internet, with approximately 20 million computers interconnected. The number of people connected to the Internet at any one time is currently increasing at a very approximate rate of 35 every 20 seconds. There are well over 100 million web pages and a simple search on one of the many Internet search engines consisting of the word “computer” (being a term which is likely to be included in a large number of web site pages because many such web sites are devoted to computing and related technologies) can regularly result in links to over one million of such pages.

The vast majority of web pages are essentially individual computer files comprising a mixture of text, graphics, background images, and animations. Each page can be written in a variety of different formats based on what is known as a “markup” language. Internet browsers, i.e. those computer programs which allow their user to view web pages, are generally capable of interpreting all the various markup languages in which a web page may be written and thus display the web page in a desired manner. Such markup languages are used because in the early days of the Internet and to a lesser extent today, there were so many different computer packages available for presenting information on a page on a computer screen and so many ways of increasing the size, spacing, and formatting of text that there was a need for a universal language which could be interpreted by a simple program, i.e. the browser. Hypertext Markup Language (or HTML as the language is more commonly known) consists of a number of “tags” which provide information to the browser decoding same, usually as the information is received through the telephone line or across a LAN, where the information specified within the said tags should be displayed on the web page.

Modern HTML consists of a great many tags that constrain the browser to display information within the web page in a certain manner, and more recently, certain of these tags can be used to inform the browser of existence of an executable program within the tag. Most modern browsers possess the capability to execute lines of program code within web page information, and those that do not can be provided with a “plug-in” module program that allows this functionality.

JavaScript (Trademark), ASP (Active Server Pages, Trade Mark), and VB Script (Visual Basic Scripting, Trade Mark) are all examples of computer programming languages which may be incorporated within a web page to increase the functionality thereof, allow for dynamic alteration of web pages depending on the circumstances and program variables, and which can be executed “on the fly” by modern browsers.

The above executable languages have only recently begun to be extensively implemented in web pages to control their content dependent on certain variables, for example, the particular personal choice of the user of the browser. In general, such languages only serve to increase the overall byte size of the HTML file being downloaded and read by the browser. Although the functionality, which such languages provide, is in certain circumstances invaluable, there is an increase in the amount of Internet traffic as a result and the time taken for the HTML file to be downloaded is thus increased.

In the light of the above, it will be appreciated that any slight reduction in the amount of Internet traffic could be invaluable.

The invention thus has as its primary object the provision of a means for the reduction of Internet traffic.

### SUMMARY OF THE INVENTION

According to the invention there is provided a compression technique for compressing a file containing tags, information, and code constituted of simple text readable and/or executable by a browser program for display therein, said technique comprising the steps of analyzing the file for the number of instances of particular segments of text, replacing the most commonly occurring segments with control codes specific to that matter being replaced to create a compression string of uncompressed textual matter and control codes, and creating look-up table means for facilitating the recognition and replacement of the control codes during subsequent expansion of the compression string.

Preferably, the compression string is repackaged in an output file having at least one pair of tags readable and/or executable by a browser.

Preferably the look-up table means is additionally repackaged in the output file of the process.

It is further preferable that the repackaging of the compression string and the look-up table means in the output file is accompanied by the insertion of a browser executable expansion routine, which expands the compression string.

Most preferably, the compression string and the look-up string are provided in the form of variable definitions to the browser.

It is yet further preferable that the output file consists only of initialization and termination tags, immediately followed and preceded with script identifying tags which bound the compression string, the look-up string, and the browser executable expansion routine.

According to a second aspect of the invention there is also provided a file when compressed according to the compression technique as specified in the primary aspect of the invention.

According to a third aspect of the invention there is provided a compression string and look-up means resulting from the application of the compression technique according to the invention.

According to a fourth aspect of the invention there is provided an expansion technique for creating a web page containing tags, information, and code constituted of simple text readable and/or executable by a browser program for display therein, constituting the steps of consecutively analyzing each character or group of characters of a compression string consisting at least of uncompressed textual matter and control codes, replacing control codes within the compression string with textual matter corresponding to the particular control code as contained in look-up means to create a string of textual matter interpretable by a browser, and outputting said resulting textual matter for display by said browser.

Preferably the output of textual matter occurs simultaneously with the expansion of the compression string.

Preferably the executable code within the browser readable file is implemented in javascript™ or VB Script™.

The fundamental advantages of the compression technique according to the invention are that web pages can be compressed by a factor of between 40-60% while remaining entirely readable by the vast majority of the browser programs currently in use in the world.

The underlying inventive concept of the invention lies in the realization of the inventor that web pages consists of a large number of often identical mark-up language tags which can be replaced by control codes, together with any textual matter within the file which appears frequently within said file. Additionally, the realization that the execution of computer code by the browser program on the user's computer is in all cases a much speedier process than the transfer of the information constituting a file through an analogue or digital telephone line, company LAN or WAN (Wide Area Network), and accordingly it is far more efficient to use executable code to expand and reconstitute the original web page at the user's computer than to download an uncompressed version of the web page.

A further advantage of the invention is realized on the company “Intranet” where a company's information is presented to the employees in the form of predominantly text-based web pages. Company Intranets are exceedingly bandwidth-intensive in that a very large amount of information can be transmitted over the company network. The reduction of Intranet traffic, which would be obtained by compression of all the said web pages, would reduce network traffic, and thus release network resources for the transmission of additional information. Ultimately, users would not only experience an increase in speed with which they could view information as a result of the compression technique according to the invention, but the speed with which any information reached a particular machine over the network would increase in general because of the reduction in network traffic.

Experimentation has shown that the compression method according to the invention can achieve 40-60% compression depending on the content of a particular page. For example, web pages consisting of a large number of images will not be compressed as efficiently as web pages consisting predominantly of text, but the mere fact that any web page comprises at least a pair of identical tags (the structure of mark-up languages necessitates this) renders all web pages compressible to some degree by the method according to the invention.

### BRIEF DESCRIPTION OF THE DRAWINGS

A specific embodiment of the invention is now described by way of example with reference to the accompanying figures, which comprise lines of JavaScript™ code used in the invention:

FIG. 1 shows an example of a file readable by a browser and compressed according to the invention;

FIG. 1A shows the original source HTML code on which the compression according to the invention was conducted to result in the code shown in FIG. 1; and

FIGS. 2-6 show example code used for the compression of conventional web pages.

### DETAILED DESCRIPTION

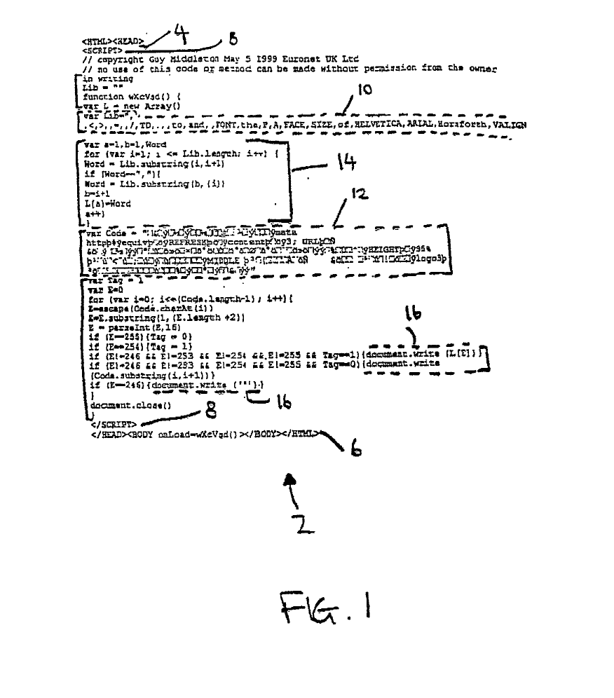

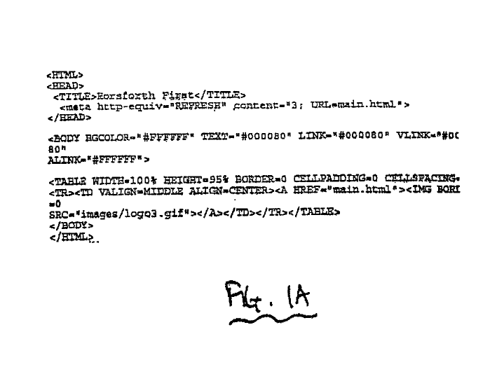

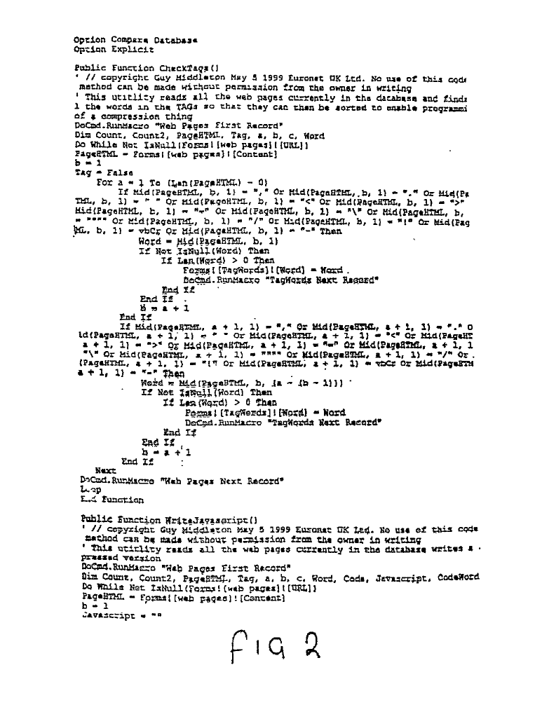

Referring firstly to FIG. 1, there shown is simple textual representation 2 of a computer file which is both readable by a modern browser program. The file contains conventional hypertext mark-up language tags 4, 6 that those skilled in the art will immediately recognize as indicating to the browser program the beginning and end of the web page. The “<SCRIPT>” and “</SCRIPT>” tags 8 indicate to the browser program that what text exists between those tags is not to be processed as commands relating to the displaying of convention web page information, but is to be processed as lines of executable code. Thus it will be understood that the compressed file 2 consists almost entirely of executable code, the only exception being the tags 4, 6 that inform the browser that the file is readable as a web page and the tags 8 which instruct the browser to execute lines of code.

The original web page from which the compressed file 2 was derived is shown in FIG. 1A, and it can be instantly appreciated that there is much repetition of the text appearing within the various tags. The invention takes particular advantage of the fact that mark-up languages work on the principle that each particular piece of text which is to appear with certain formatting on the web page is preceded and followed by one or more pairs of tags to instruct the browser to apply specific formatting to the particular piece of text between the respective tags. Accordingly, practically every tag within a web page appears twice. Web pages, which are particularly formatting-rich, can thus be comprised with greater efficiency as the process removes relevant tags.

The examples of the compressed file 2 and the original web page shown in FIGS. 1 and 1A are provided solely to demonstrate the operation of the invention, and in reality it may be imprudent to compress web pages of the type shown in FIG. 1A because the resulting compressed file is actually larger than the original. A clearer understanding of the number of repeated tags incorporated in a typical web page can be gleaned from FIGS. 7-15, which show the number of lines code typically used in a particularly formatting-rich web page. It is to be mentioned that the invention encompasses the compression not only of tags, but of every single character which constitutes the web page and whose replacement may result in optimized compression because of their repetition throughout the document. Examples include commonly used words such as “the”, curly brackets/braces, greater than and less than signs, and the like.

Referring again to FIG. 1, within the compressed file 2 there is a look-up string 10 (the length of which is much longer than shown in the Figure), and a compression string 12 comprising control codes identified primarily by square boxes and textual matter which the compression technique statistically determined it would be inefficient to replace with control codes.

An expansion cycle sequentially counts through each individual character within the compression string and expands the string if a control code is encountered by replacing said control code with its corresponding entry from the look-up string 10, and write commands 16 instruct the browser to display portions of the expanded string sequentially and during execution of the code. In this manner the impression to the user during code execution is that the web page is being conventionally downloaded albeit much quicker than would be usual for that particular user's connection.

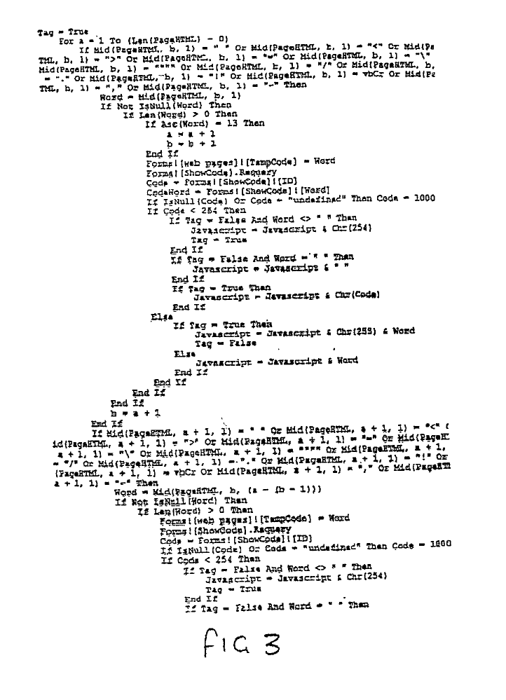

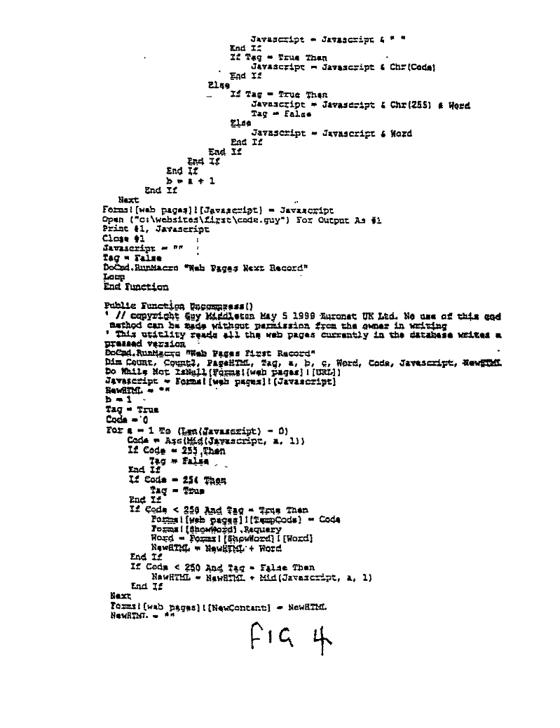

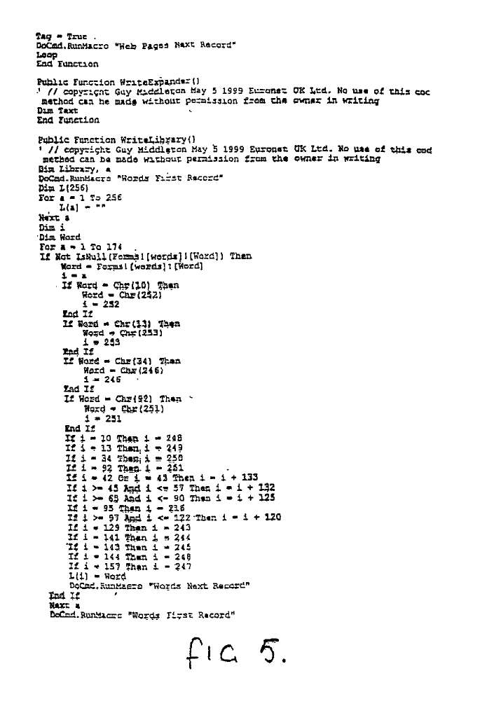

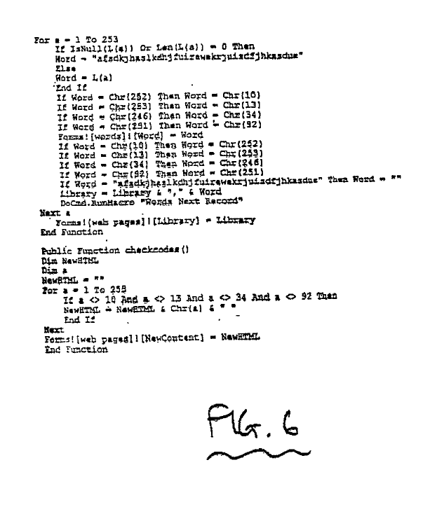

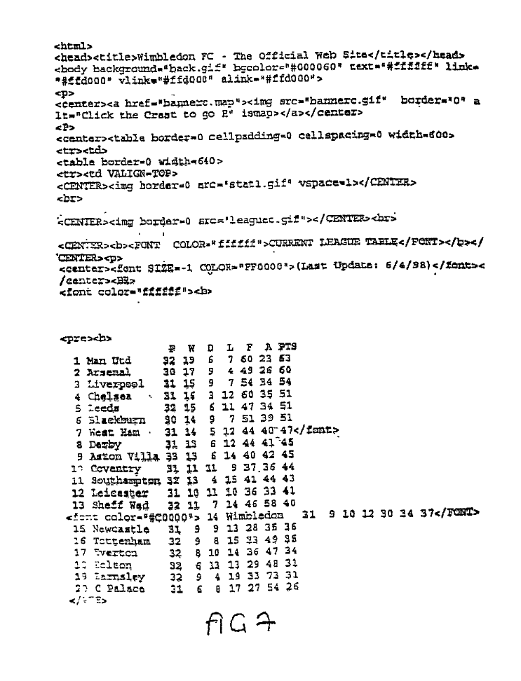

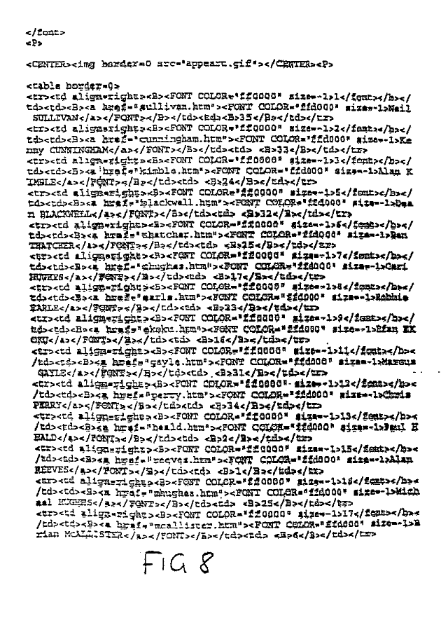

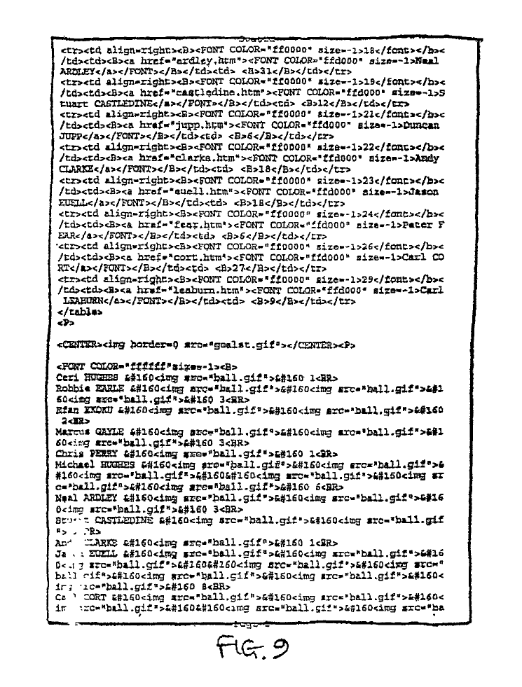

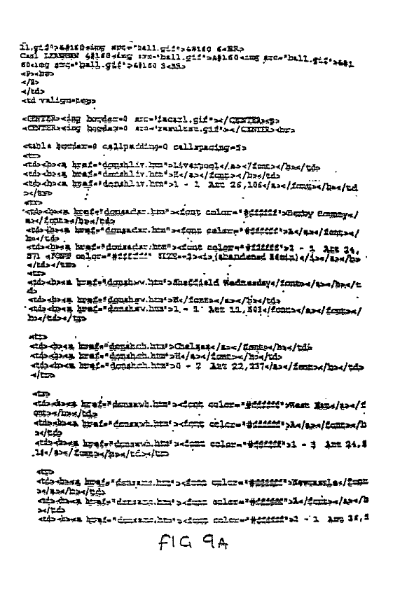

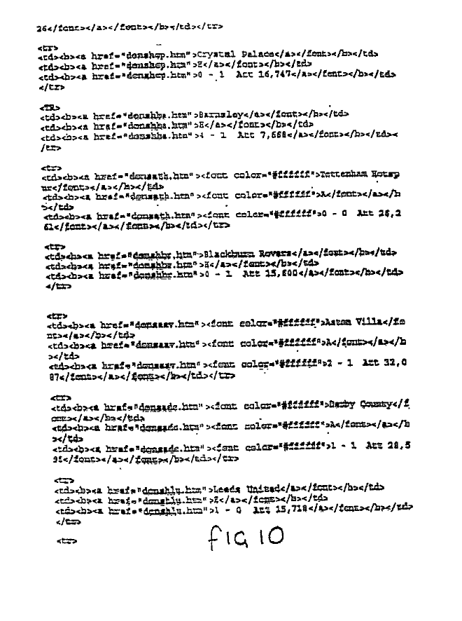

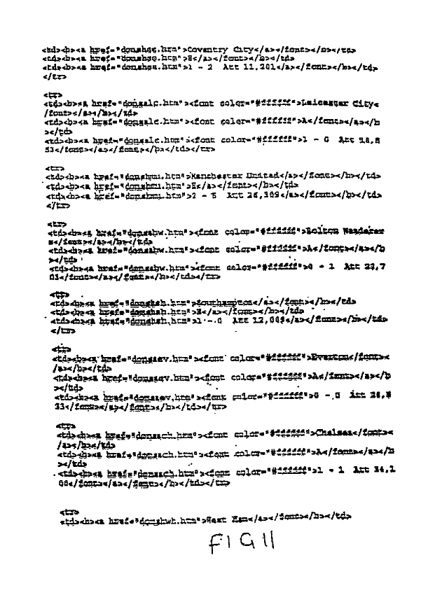

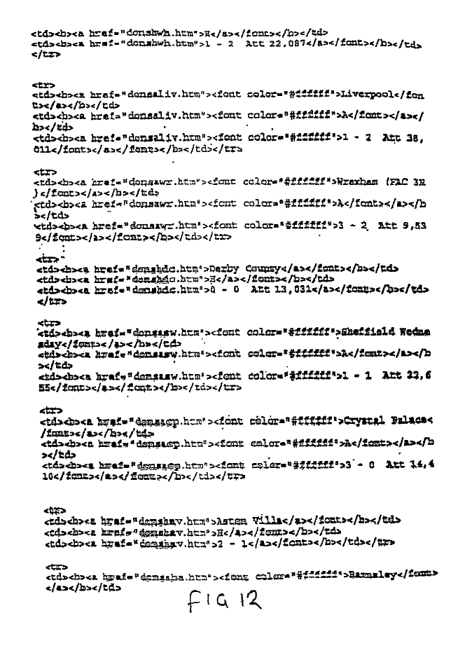

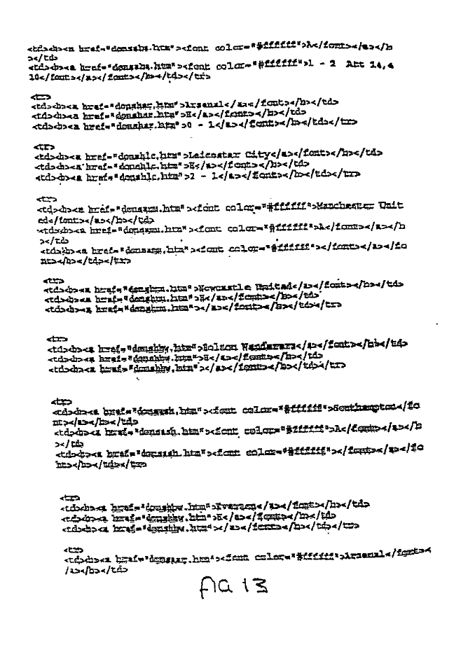

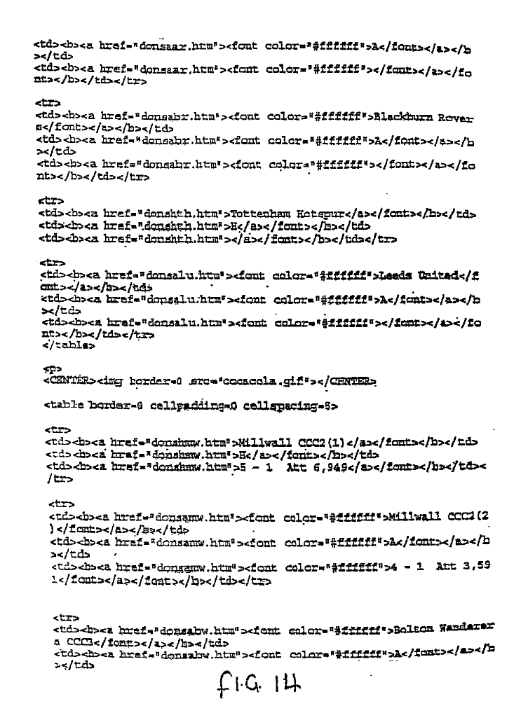

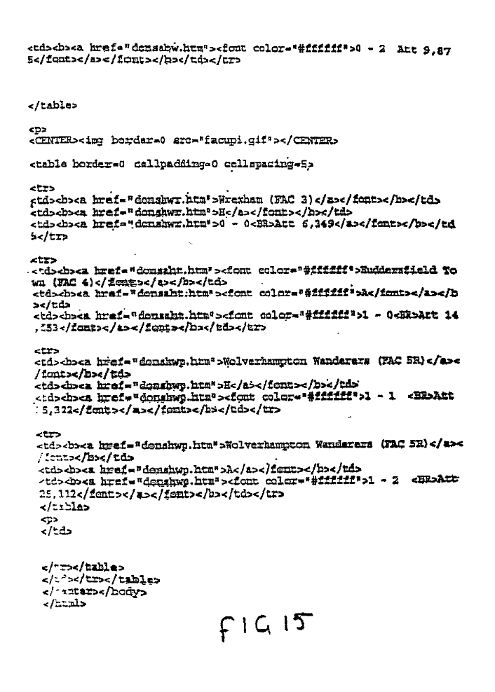

As mentioned above, FIGS. 2-6 show a specific embodiment of how the compression technique according to the invention could be implemented in lines of code, and from such code it will be immediately apparent to the skilled person how the compression technique ascertains which textual matter within the original web page is to be replaced with a control code.

In a modified embodiment of the invention, it is foreseen by the applicant that a specific expansion routine similar to that disclosed in the code of FIG. 1 could be provided as a plug-in for existing browsers such that only the compression string and the look-up string need be downloaded onto a user's computer for expansion by a suitably enabled browser. In this circumstance, the compressed file 2 would consist only of the initial and terminal tags 4, 6 and of pairs of tags, which would identify the said strings encapsulated between said pairs of tags to the browser for expansion of the compression sting using the look-up string. In this manner, yet further compression efficiency could be achieved. As an alternative to a plug-in, the executable expansion routine could be hard-coded within the code kernel of the browser, or otherwise integrated into the code that controls the operation of the browser.

In a yet further modification of the invention, it is foreseen that the only the compression string need be included in the compressed file and encapsulated between a suitable pair of identifying tags, with both the expansion routine and a universally applicable look up string being incorporated into the browser program on a user's computer. In this manner the size of web pages to be downloaded could be minimized, and compression efficiency concomitantly maximized.

Now that the invention has been described,

1. A compression method for compressing a file containing tags, information, and code constituted of simple text readable and/or executable by a browser program for display therein, said technique comprising the steps of analyzing the file for the number of instances of particular segments of text, replacing the most commonly occurring segments with control codes specific to that matter being replaced to create a compression string of uncompressed textual matter and control codes, and creating look-up table means for facilitating the recognition and replacement of the control codes during subsequent expansion of the compression string.

2. A method according to claim 1 wherein the compression string is repackaged in an output file having at least one pair of tags readable and/or executable by a browser.

3. A method according to claim 2 wherein the look-up table means is additionally repackaged in the output file.

4. A method according to claim 3 wherein the repackaging of the compression string and the look-up table means in the output file is accompanied by the insertion of a browser executable expansion routine which expands the compression string.

5. A method according to claim 4 wherein the compression string and the look-up string are provided in the form of variable definitions to the browser.

6. A method according to claim 5 wherein the output file consists only of initialization and termination tags, immediately followed and preceded with script identifying tags which bound the compression string, the look-up string, and the browser executable expansion routine.

7. A method according to claim 6 wherein said method is performed on a text markup file that can be read by a suitable computer browser program.

8. A compression string derived from a file containing tags, information, and code constituted of simple text readable and/or executable by a browser program for display therein, said string resulting from an analysis of the file for the number of instances of particular segments of text followed by a replacement of the most commonly occurring segments with control codes specific to that matter being replaced, said compression string comprising uncompressed textual matter and control codes.

9. A compression string according to claim 8 when provided together with look-up table means for facilitating the recognition and replacement of the control codes during subsequent expansion of the compression string.

10. An expansion technique for creating a computer browser program readable file containing tags, information and code constituted of simple text readable and/or executable by said browser program for display therein, constituting the steps of consecutively analyzing each character or group of characters of a compression string consisting at least of uncompressed textual matter and control codes, replacing control codes within the compression string with textual matter corresponding to the particular control code as contained in look-up means to create a string of textual matter interpretable by a browser, and outputting said resulting textual matter for display by said browser.

11. A technique according to claim 10 wherein the output of textual matter occurs simultaneously with the expansion of the compression string.

12. A technique according to claim 11 wherein the executable code within the browser readable file is implemented in JavaScript198 .

13. A technique according to claim 12 wherein the executable code within the browser readable file is implemented in YB Script™.
